(19) United States
(12) Patent Application Publication
(10) Pub. No.: US 2016/0062535 A1
(43) Pub. Date: Mar. 3, 2016

(54) ELECTRONIC APPARATUS AND CONTROL METHOD

(71) Applicant: Kabushiki Kaisha Toshiba, Tokyo (JP)

(72) Inventor: Norikazu Nagasawa, Ome Tokyo (JP)

(21) Appl. No.: 14/670,245

(22) Filed: Mar. 26, 2015

Related U.S. Application Data
(60) Provisional application No. 62/042,670, filed on Aug. 27, 2014.

(51) Int. Cl. G06F 3/041; G06K 9/62; G06F 3/0488

(52) U.S. Cl. CPC G06F 3/0416; G06F 3/0412; G06F 3/04883; G06K 9/6255; G06K 2209/01; G06F 2203/04808

(57) ABSTRACT

According to one embodiment, an electronic apparatus includes a touchscreen display and a controller. The controller is configured to switch a frame rate of image display on the touchscreen display from a first frame rate to a second frame rate which is higher than the first frame rate when a first program is activated. The first program is configured to display, on the touchscreen display, an object showing handwriting in response to a handwriting input operation on the touchscreen display.

### CROSS-REFERENCE TO RELATED APPLICATIONS

This application claims the benefit of U.S. Provisional Application No. 62/042,670, filed Aug. 27, 2014, the entire contents of which are incorporated herein by reference.

### FIELD

Embodiments described herein relate generally to an electronic apparatus and a control method.

### BACKGROUND

Recently, electronic apparatuses such as tablet computers in which a handwriting input operation can be performed on a display screen have become widespread. Many of these electronic apparatuses have optical character recognition (OCR) functions to recognize handwritten characters and convert them into text data. Accordingly, such electronic apparatuses are increasingly being used in, for example, meetings to take notes such as the minutes of the meetings.

On the other hand, measures to efficiently reduce a time lag from the handwriting input operation on the display screen to the display of the handwriting on the display screen, for example, while increasing power consumption as little as possible are desired.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing an outer appearance of an electronic apparatus according to an embodiment.

FIG. 2 is an exemplary view showing a system configuration of the electronic apparatus according to the embodiment.

FIG. 3 is an exemplary view showing an example of situations in which a character is handwritten on a display screen of the electronic apparatus according to the embodiment.

FIG. 4 is an exemplary view showing function blocks concerning performance improvement of handwriting input in consideration of power saving of the electronic apparatus according to the embodiment.

FIG. 5 is an exemplary timing chart for describing an operating principle concerning the performance improvement of handwriting input in consideration of power saving of the electronic apparatus according to the embodiment.

FIG. 6 is an exemplary flowchart showing operating procedures concerning the performance improvement of handwriting input in consideration of power saving of the electronic apparatus according to the embodiment.

### DETAILED DESCRIPTION

Various embodiments will be described hereinafter with reference to the accompanying drawings.

In general, according to one embodiment, an electronic apparatus comprises a touchscreen display and a controller. The controller is configured to switch a frame rate of image display on the touchscreen display from a first frame rate to a second frame rate which is higher than the first frame rate when a first program is activated. The first program is configured to display, on the touchscreen display, an object showing handwriting in response to a handwriting input operation on the touchscreen display.

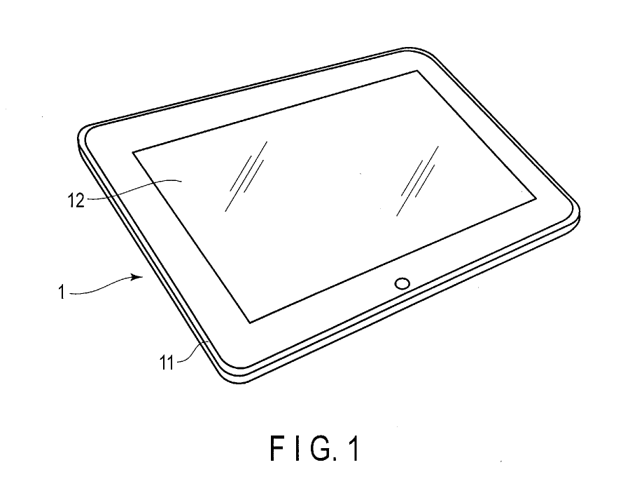

FIG. 1 is an exemplary view showing an outer appearance of the electronic apparatus according to the embodiment. Suppose the electronic apparatus according to the embodiment is realized as a tablet computer 1. As shown in FIG. 1, the tablet computer 1 comprises a main body 11 and a touchscreen display 12.

The main body 11 comprises a flat box housing. A flat panel display and a sensor for detecting a contact position of a finger, a stylus or the like on a screen of the flat panel display are mounted in the touchscreen display 12. The flat panel display is, for example, an LCD. The sensor is, for example, a capacitance type touchpanel or an electromagnetic induction type digitizer. Suppose both the touchpanel and the digitizer are mounted in the touchscreen display 12. It should be noted that if the touchpanel is compatible with an active stylus, the digitizer is not necessary.

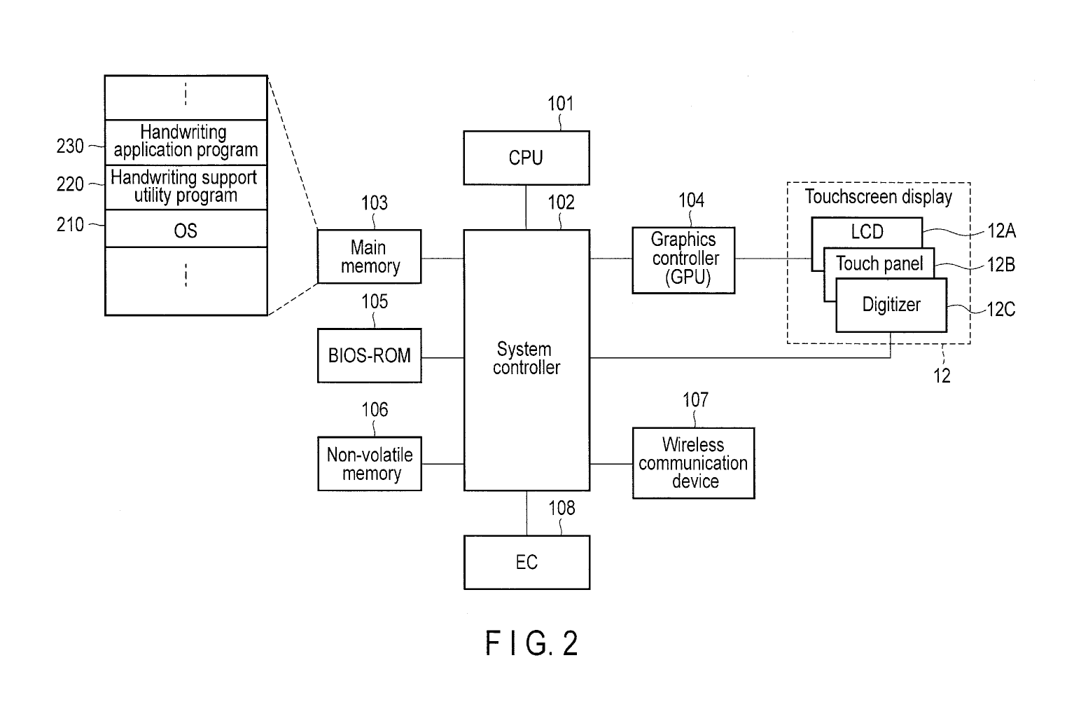

FIG. 2 is an exemplary view showing a system configuration of the tablet computer 1.

As shown in FIG. 2, the tablet computer 1 comprises a CPU 101, a system controller 102, a main memory 103, a graphics controller (GPU) 104, a BIOS-ROM 105, a non-volatile memory 106, a wireless communication device 107, an embedded controller (EC) 108, etc.

The CPU 101 is a processor which controls operations of various components in the tablet computer 1. The CPU 101 loads various types of software from the non-volatile memory 106 to the main memory 103 and executes it. The software includes an operating system (OS) 210 and various application programs including utilities. The various application programs include a handwriting support utility program 220 and a handwriting application program 230.

The handwriting application program 230 is a program which can accept the handwriting input operation on the touchscreen display 12, and displays the object showing handwriting on the touchscreen display 12 in response to the handwriting input operation. The handwriting application program 230 comprises an OCR function for recognizing a character handwritten on the touchscreen display 12. A user can create an electronic document by writing the document on the touchscreen display 12 using the handwriting application program 230. The handwriting support utility program 220 is a program for efficiently reducing a time lag from the handwriting input operation on the touchscreen display 12 to the display of the handwriting on the touchscreen display 12, when a user uses the handwriting application program 230. Detailed description thereof will be provided later.

Further, the CPU 101 also executes a BIOS stored in the BIOS-ROM 105. The BIOS is a program for controlling hardware.

The system controller 102 is a device which connects a local bus of the CPU 101 and various components. Various controllers for controlling various components such as a memory controller which controls access of the main memory 103 and a touchpanel controller which controls driving of a touchpanel 12B mounted in the touchscreen display 12 are built in the system controller 102. The tablet computer 1 can switch a scan rate of the touchpanel 12B or a scan rate of a digitizer 12C (mounted in the touchscreen display 12 in the same manner as the touchpanel 12B) through the system controller 102 including the various controllers. The scan rate is a value indicating the number of times per unit time of detecting the contact position of the finger, stylus or the like on the touchscreen display 12 (the touchpanel 12B and the digitizer 12C).

The graphics controller 104 is a display controller which controls an LCD 12A mounted in the touchscreen display 12. The LCD 12A displays an image including the object showing the handwriting on the basis of a display signal generated by the graphics controller 104. The tablet computer 1 can switch a frame rate of an image displayed on the LCD 12A through the graphics controller 104. The frame rate is a value indicating the number of times per unit time of rewriting the image displayed on the touchscreen display 12 (the LCD 12A). It should be noted that a refresh rate of the LCD 12A is controlled by the graphics controller 104 to have the same value as the frame rate of the image. The frame rate of the image displayed on the LCD 12A and the refresh rate of the LCD 12A may be hereinafter generally called the frame rate of the LCD 12A.

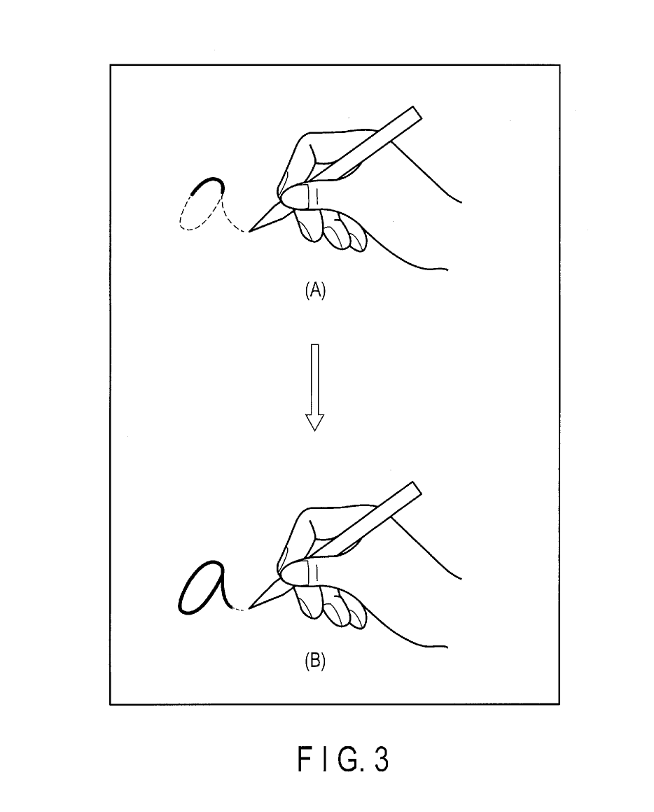

FIG. 3 shows an example of situations in which a character is handwritten on the touchscreen display 12. Suppose a user handwrites a character “a”, as shown in FIG. 3. In FIG. 3, (A) shows that a large time lag is generated between the handwriting of the character “a” and the display of the character “a”.

As described above, the contact position of the finger, stylus or the like on the touchscreen display 12 is detected on the basis of a scan rate set at that moment by the touchpanel 12B or the digitizer 12C. Further, the handwriting (object) displayed on the touchscreen display 12 by the handwriting application program 230 is rewritten on the basis of a frame rate set at that moment by the graphics controller 104. That is, a time lag from the handwriting input operation on the touchscreen display 12 to the display of handwriting on the touchscreen display 12, when the handwriting application program 230 is used, depends on the scan rate and frame rate. Thus, this time lag can be reduced by increasing the scan rate and frame rate. In other words, followability of display of handwriting on the touchscreen display 12 with respect to the handwriting input operation on the touchscreen display 12 can be improved. In FIG. 3, (B) shows that the time lag from the handwriting of the character “a” and the display of the character “a” is reduced by increasing the scan rate and frame rate.

However, the increase of the scan rate and frame rate increases a power consumption amount of the tablet computer 1. The increase of the power consumption amount should be avoided as much as possible in the tablet computer 1 which can be driven by a battery on the assumption that it is carried by a user. Then, the handwriting support utility program 220 basically executes the processing of switching the scan rate and frame rate from a normal rate to a high rate if the handwriting application program 230 is activated, and of returning the scan rate and frame rate from the high rate to the normal rate when the handwriting application program 230 is terminated. As described above, performance improvement of handwriting input in consideration of power saving is realized in the tablet computer 1 not by always increasing the scan rate and frame rate but by increasing the scan rate and frame rate only when necessary.

The wireless communication device 107 is a device configured to execute wireless communication such as a wireless LAN and 3G mobile communication. The EC 108 is a single-chip microcomputer including an embedded controller for power management. The EC 108 comprises a function of powering on or off the tablet computer 1 in accordance with an operation of a power button by a user.

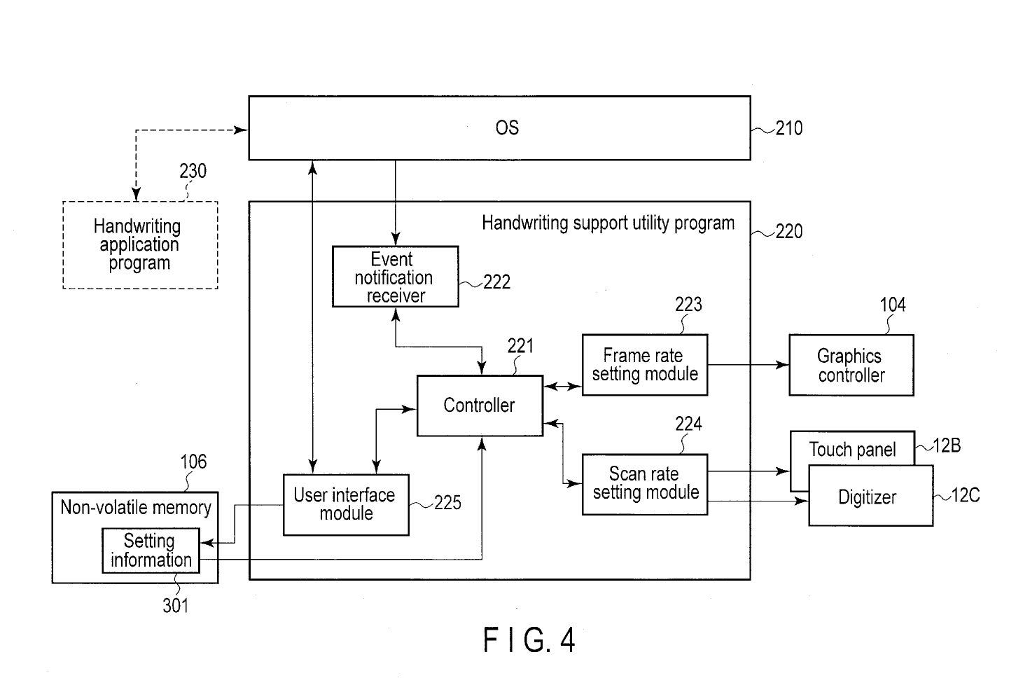

FIG. 4 is an exemplary view showing function blocks concerning performance improvement of handwriting input in consideration of power saving of the tablet computer 1.

As shown in FIG. 4, the handwriting support utility program 220 comprises a controller 221, an event notification receiver 222, a frame rate setting module 223, a scan rate setting module 224 and a user interface module 225.

The controller 221 is a module which controls the operation of the whole of the handwriting support utility program 220. More specifically, the event notification receiver 222, the frame rate setting module 223, the scan rate setting module 224 and the user interface module 225 operate under control of the controller 221.

The event notification receiver 222 is a module which receives, from the OS 210, notification indicating that such events as described below have occurred, that is, the handwriting application program 230 has been activated, the handwriting application program 230 has been terminated, and contact of a finger, a stylus or the like on the touchscreen display 12 has been detected. The handwriting support utility program 220 requests the OS 210 to indicate the occurrence of these events, when they occur, for example, in the initial processing at the time of activation.

The frame rate setting module 223 is a module which switches the frame rate of the LCD 12A, the frame rate of the image output from the GPU 104 to the LCD, and the refresh rate of the LCD 12A between the normal rate and the high rate. A frame rate setting module 233 sets a value corresponding to multiples of 2 of the normal rate as the high rate. For example, if the normal rate is at 60 Hz, the high rate is at 120 Hz, 240 Hz, or the like. The scan rate setting module 224 is a module which switches the scan rates of the touchpanel 12B and the digitizer 12C between the normal rate and the high rate.

The user interface module 225 is a module for enabling a user to perform various settings concerning the handwriting support utility program 220. Contents of various settings by a user are stored in the non-volatile memory 106 as setting information 301. The handwriting support utility program 220 operates on the basis of the setting information 301 as intended by the user. Information of an application program in which the switching of the frame rate and scan rate should be executed is first included in the contents set by the user interface module 225. The handwriting support utility program 220 requests the OS 210 to indicate activation and end of the application program. This allows the existing handwriting application program 230 lacking a function of switching the frame rate and scan rate to execute the switching of the frame rate and scan rate.

Naturally, the function of switching the frame rate and scan rate may be provided in the handwriting application program 230 itself. In this case, the handwriting support utility program 220 is not necessary. It should be noted that if the handwriting support utility program 220 is interposed as described herein, the switching between the frame rate and scan rate can be performed in synchronization with the activation and end of a plurality of existing application programs lacking the function of switching the frame rate and scan rate which display the object showing the handwriting on the touchscreen display 12 in response to the handwriting input operation (by setting information of each of the application programs), the application programs being programs which can accept the handwriting input operation on the touchscreen display 12.

Further, information indicating whether the power saving function is operated or not when the handwriting application program 230 is in operation is secondly included in the contents set by the user interface module 225. The handwriting support utility program 220 includes the power saving function of returning the frame rate and scan rate from the high rate to the normal rate if the handwriting input operation on the touchscreen display 12 stopped beyond a base time after the frame rate and scan rate are switched from the normal rate to the high rate in accordance with the activation of the handwriting application program 230. A user can set whether the power saving function is operated or not. It should be noted that when the power saving function is operated, the handwriting support utility program 220 may set the frame rate and scan rate to be lower than the normal rate. If the power saving function is set to be operated, the user can further set the base time (user setting time b).

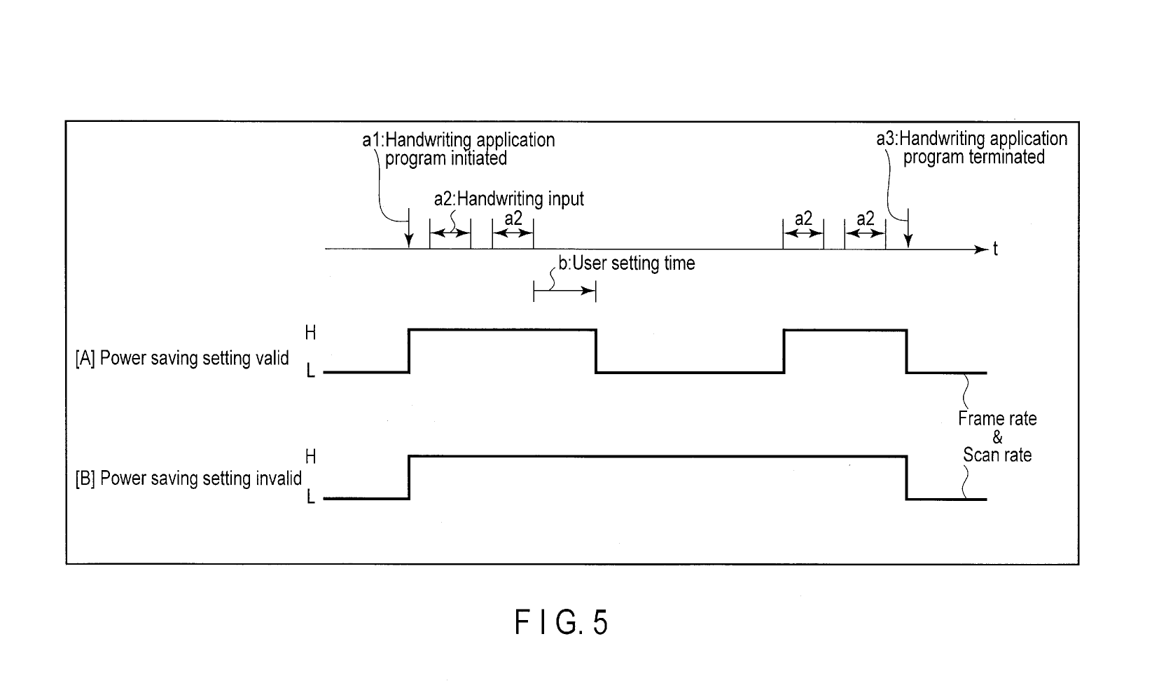

FIG. 5 is an exemplary timing chart for describing an operating principle of the handwriting support utility program 220.

In FIG. 5, a1 indicates a time when the handwriting application program 230 is activated. Further, a2 indicates a period during which a handwriting input is performed on the touchscreen display 12. Moreover, a3 indicates a time when the handwriting application program 230 is terminated.

First, an operating principle of the handwriting support utility program 220 when the power saving function is set to be operated ([A] in FIG. 5) will be described.

When the handwriting application program 230 is activated, the handwriting support utility program 220 switches the frame rate of the LCD 12A and the scan rates of the touchpanel 12B and the digitizer 12C from the normal rate (L) to the high rate (H). Notification received from the OS 210 by the event notification receiver 222 causes the handwriting support utility program 220 to detect that the handwriting application program 230 is activated.

When the power saving function is operated, the handwriting support utility program 220 monitors an elapsed time since the contact of the finger, stylus or the like on the touchscreen display 12 is last detected by the touchpanel 12B or the digitizer 12C. More specifically, the handwriting support utility program 220 monitors the elapsed time since the event notification receiver 222 receives, from the OS 210, the notification indicating that the contact of the finger, stylus or the like on the touchscreen display 12 has been detected. The handwriting support utility program 220 switches the frame rate of the LCD 12A and the scan rates of the touchpanel 12B and the digitizer 12C from the high rate to the normal rate if the elapsed time is beyond user setting time b set by the user using the user interface module 225. At this moment, the handwriting support utility program 220 may set the frame rate and scan rate to be lower than the normal rate, as described above.

Subsequently, the handwriting support utility program 220 monitors whether the contact of the finger, stylus or the like on the touchscreen display 12 has been detected by the touchpanel 12B or the digitizer 12C or not. More specifically, the handwriting support utility program 220 monitors whether the event notification receiver 222 receives or not, from the OS 210, the notification indicating that the contact of the finger, stylus or the like on the touchscreen display 12 has been detected. If (the handwriting input is) detected, the handwriting support utility program 220 switches the frame rate of the LCD 12A and the scan rates of the touchpanel 12B and the digitizer 12C from the normal rate to the high rate.

Then, the handwriting support utility program 220 switches the frame rate of the LCD 12A and the scan rates of the touchpanel 12B and the digitizer 12C from the high rate to the normal rate when the handwriting application program 230 is terminated. Notification received from the OS 210 by the event notification receiver 222 causes the handwriting support utility program 220 to detect that the handwriting application program 230 is terminated.

Next, an operating principle of the handwriting support utility program 220 in the case where the power saving function is set to be disabled ([B] in FIG. 5) will be described.

Also in this case, the handwriting support utility program 220 switches the frame rate of the LCD 12A and the scan rates of the touchpanel 12B and the digitizer 12C from the normal rate to the high rate in accordance with the activation of the handwriting application program 230. When the power saving function is disabled, the handwriting support utility program 220 maintains the frame rate of the LCD 12A and the scan rates of the touchpanel 12B and the digitizer 12C to be the high rate even if the handwriting input is stopped beyond user setting time b. For example, a user who regards followability of display of handwriting at the time of restarting the handwriting input as important can disable the power saving function.

Then, the handwriting support utility program 220 switches the frame rate of the LCD 12A and the scan rates of the touchpanel 12B and the digitizer 12C from the high rate to the normal rate in accordance with the end of the handwriting application program 230.

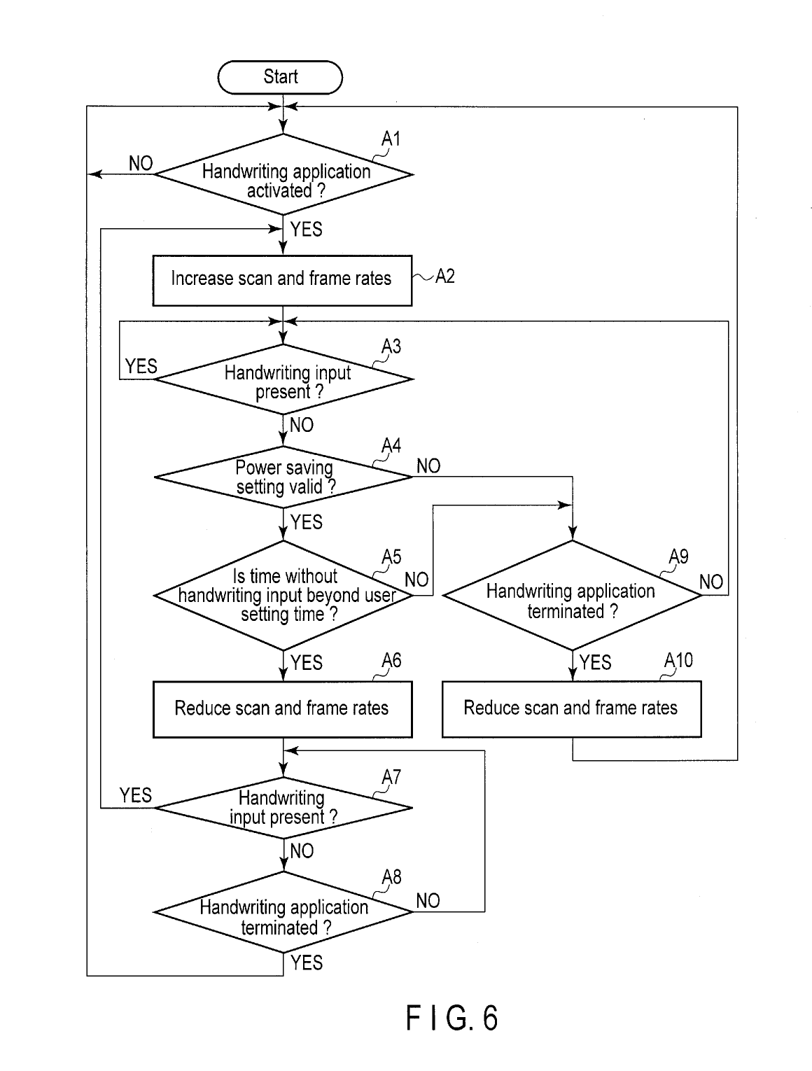

FIG. 6 is an exemplary flowchart showing operating procedures of the handwriting support utility program 220.

When the handwriting application program 230 is activated (YES in block A1), the handwriting support utility program 220 switches the frame rate of the LCD 12A and the scan rates of the touchpanel 12B and the digitizer 12C from the normal rate to the high rate (block A2). The handwriting support utility program 220 monitors whether the handwriting input operation on the touchscreen display 12 is present or not (block A3). If the handwriting input operation is not present (NO in block A3) and if the power saving function is set valid (YES in block A4), the handwriting support utility program 220 determines whether the elapsed time from the stop of the handwriting input operation is beyond the user setting time (block A5).

If the elapsed time from the stop of the handwriting input operation is beyond the user setting time (YES in block A5), the handwriting support utility program 220 switches the frame rate of the LCD 12A and the scan rates of the touchpanel 12B and the digitizer 12C from the high rate to the normal rate (block A6). Then, the handwriting support utility program 220 monitors whether the handwriting input operation on the touchscreen display 12 is present or not (block A7). If the handwriting input operation is restarted (YES in block A7), the processing returns to block A2, and the handwriting support utility program 220 switches the frame rate of the LCD 12A and the scan rates of the touchpanel 12B and the digitizer 12C from the normal rate to the high rate. Further, if the handwriting application program 230 is terminated (YES in block A8), the processing returns to block A1 with the frame rate of the LCD 12A and the scan rates of the touchpanel 12B and the digitizer 12C switched to the normal rate, and the handwriting support utility program 220 waits for the activation of the handwriting application program 230.

Even if the handwriting input operation is not present (NO in block A3) and if the power saving function is set invalid (NO in block A4), the handwriting support utility program 220 keeps the frame rate of the LCD 12A and the scan rates of the touchpanel 12B and the digitizer 12C switched to the high rate, and the processing returns to block A3. The handwriting support utility program 220 monitors whether the handwriting input operation on the touchscreen display 12 is present or not. If the handwriting application program 230 is terminated (YES in block A9), the handwriting support utility program 220 switches the frame rate of the LCD 12A and the scan rates of the touchpanel 12B and the digitizer 12C from the high rate to the normal rate (block A10), and the processing returns to block A1. The handwriting support utility program 220 waits for the activation of the handwriting application program 230.

Further, if the power saving function is set valid (YES in block A4) and if the elapsed time from the stop of the handwriting input operation is not beyond the user setting time (NO in block A5), the handwriting support utility program 220 keeps the frame rate of the LCD 12A and the scan rates of the touchpanel 12B and the digitizer 12C switched to the high rate, and the processing returns to block A3. The handwriting support utility program 220 monitors whether the handwriting input operation of the touchscreen display 12 is present or not. Also in this case, if the handwriting application program 230 is terminated (YES in block A9), the handwriting support utility program 220 switches the frame rate of the LCD 12A and the scan rates of the touchpanel 12B and the digitizer 12C from the high rate to the normal rate (block A10), and the processing returns to block Al. The handwriting support utility program 220 waits for the activation of the handwriting application program 230.

As described above, the tablet computer 1 according to this embodiment allows a time lag from the handwriting input operation on a display screen to the display of the handwriting on the display screen to be efficiently reduced without increasing, for example, a power consumption amount as much as possible.

Incidentally, an example of deteriorating the frame rate of the LCD 12A if the handwriting input operation on the touchscreen display 12 is stopped beyond the base time when the power saving function is in operation has been shown in the above description. If the LCD 12A has a self-refresh function of autonomously rewriting a display image, the graphics controller 104 may be stopped by operating the self-refresh function, instead of deteriorating the frame rate of the LCD 12A. This allows further power saving to be achieved.

Further, an example of executing the switching of both the frame rate and the scan rate in synchronization with the activation and end of the handwriting application program 230 has been shown in the above description; however, the embodiments are not limited to this. Followability of display of handwriting on the display screen with respect to the handwriting input operation on the display screen can be improved even if only one of the frame rate and scan rate is switched, for example, even if only the scan rate is switched in the case where the frame rate is maintained to be always sufficiently high.

Since the operating procedures of each embodiment can be realized by software (program), an advantage similar to that of each embodiment can be easily realized by installing the software in an ordinary computer through a computer-readable storage medium in which the software is stored, and executing it.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a touchscreen display; and
a controller configured to switch a frame rate of image display on the touchscreen display from a first frame rate to a second frame rate which is higher than the first frame rate when a first program is activated, the first program being configured to display, on the touchscreen display, an object showing handwriting in response to a handwriting input operation on the touchscreen display.

2. The apparatus of claim 1, wherein the controller is configured to switch a scan rate of the touchscreen display from a first scan rate to a second scan rate which is higher than the first scan rate when the first program is activated.

3. The apparatus of claim 2, wherein the controller is configured to switch the frame rate from the second frame rate to the first frame rate, and to switch the scan rate from the second scan rate to the first scan rate, when the first program is terminated.

4. The apparatus of claim 2, wherein the controller is configured to switch the frame rate from the second frame rate to the first frame rate or a third frame rate which is lower than the first frame rate, and to switch the scan rate from the second scan rate to the first scan rate or a third scan rate which is lower than the first scan rate, when the handwriting input operation on the touchscreen display is absent for a first period or more when the first program is in operation.

5. The apparatus of claim 4, wherein the controller is configured to switch the frame rate from the first frame rate or the third frame rate to the second frame rate, and to switch the scan rate from the first scan rate or the third scan rate to the second scan rate, when the handwriting input operation on the touchscreen display is restarted.

6. The apparatus of claim 4, further comprising a user interface configured to set execution or non-execution of switching of a frame rate and a scan rate in a case where the handwriting input operation on the touchscreen display is absent for the first period or more.

7. The apparatus of claim 6, wherein the user interface is capable of setting the first period.

8. The apparatus of claim 2, wherein:
the touchscreen display comprises a self-refresh function of autonomously rewriting an image which is being displayed; and
the controller is configured to operate the self-refresh function and stops a graphics controller which generates a display signal and to supply the display signal to the touchscreen display, when the handwriting input operation on the touchscreen display is absent for a first period or more when the first program is in operation.

9. The apparatus of claim 8, wherein the controller is configured to stop the self-refresh function and to re-operate the graphics controller, when the handwriting input operation on the touchscreen display is restarted.

10. The apparatus of claim 2, wherein the second frame rate comprises a value corresponding to multiples of 2 of the first frame rate.

11. The apparatus of claim 2, wherein:
the touchscreen display comprises a liquid crystal display (LCD); and
the controller is configured to switch a frame rate of image display on the LCD.

12. The apparatus of claim 2, wherein:
the touchscreen display comprises a touchpad; and
the controller is configured to switch a scan rate of the touchpad.

13. The apparatus of claim 2, wherein:
the touchscreen display comprises a digitizer; and
the controller is configured to switch a scan rate of the digitizer.

14. A control method of an electronic apparatus, the method comprising switching a frame rate of image display on a touchscreen display from a first frame rate to a second frame rate which is higher than the first frame rate, when a first program which displays an object showing handwriting on the touchscreen display in response to a handwriting input operation on the touchscreen display is activated.

15. The method of claim 14, wherein the switching comprises switching a scan rate of the touchscreen display from a first scan rate to a second scan rate which is higher than the first scan rate when the first program is activated.

16. The method of claim 15, wherein the switching comprises switching the frame rate from the second frame rate to the first frame rate, and switching the scan rate from the second scan rate to the first scan rate, when the first program is terminated.

17. The method of claim 15, wherein the switching comprises switching the frame rate from the second frame rate to the first frame rate or a third frame rate which is lower than the first frame rate, and switching the scan rate from the second scan rate to the first scan rate or a third scan rate which is lower than the first scan rate, when the handwriting input operation on the touchscreen display is absent for a first period or more when the first program is in operation.

18. The method of claim 15, wherein the switching comprises switching the frame rate from the first frame rate or the third frame rate to the second frame rate, and switching the scan rate from the first scan rate or the third scan rate to the second scan rate, when the handwriting input operation on the touchscreen display is restarted.

19. The method of claim 15, further comprising setting execution or non-execution of switching of a frame rate and a scan rate in a case where the handwriting input operation on the touchscreen display is absent for a first period or more.

20. The method of claim 19, wherein the setting comprises setting the first period.
